(19) United States
(12) Patent Application Publication
(10) Pub. No.: US 2025/0338272 A1
(43) Pub. Date: Oct. 30, 2025

(54) METHODS, ARCHITECTURES, APPARATUSES AND SYSTEMS FOR DYNAMIC GRANT UPLINK HYBRID AUTOMATIC REPEAT REQUEST OPERATION WITH NETWORK CODING

(71) Applicant: InterDigital Patent Holdings, Inc., Wilmington, DE (US)

(72) Inventors: Yifan LI, Conshohocken, PA (US); Ayesha IJAZ, Guildford (GB); Faris ALFARHAN, MONTRÉAL (CA); Pascal ADJAKPLE, Great Neck, NY (US); Ghyslain PELLETIER, Montréal (CA)

(21) Appl. No.: 18/647,060

(22) Filed: Apr. 26, 2024

(51) Int. Cl. H04W 72/1268; H04L 1/1812; H04W 72/21; H04W 72/232

(52) U.S. Cl. CPC H04W 72/1268; H04L 1/1812; H04W 72/21; H04W 72/232

(57) ABSTRACT

Procedures, apparatuses, and computer program products related to dynamic grant UL HARQ operation with network coding (NC) are described. One method may include may include receiving, from a network element, DCI that includes a grant scheduling an uplink transmission. The method may include determining, based on the DCI, information including any of (1) a number of NC protocol data units (PDUs) to be transmitted via a transport block (TB) in the uplink transmission for the NC generation associated with the identifier, (2) whether the DCI is scheduling a transmission for a new NC generation or a current NC generation, and/or (3) whether to retransmit a redundant version (RV) of a transport block (TB) that has already been transmitted or transmit a TB that carries a new redundant NC protocol data unit (PDU). The method may include transmitting, to a network element, the TB in accordance with the determined information.

### FIELD

Example embodiments described in the present disclosure are generally directed to the fields of communications, software and encoding, including, for example, to methods, architectures, apparatuses, systems related to dynamic grant uplink (UL) hybrid automatic repeat request (HARQ) operation with network coding.

### BACKGROUND

Network coding is a packet processing function that transforms a certain number of input or source packets into a number of output packets, which may be referred to as coded packets. In general, the number of input packets is greater than or equal to 2 and the number of output packets is greater than or equal to the number of input packets. The input packets that are coded together form a network coding generation.

### SUMMARY

An example embodiment may be directed to a method (e.g., that can be implemented by a WTRU) that may include receiving, from a network element, downlink control information (DCI) that includes a grant scheduling an uplink transmission. The DCI may include any of (1) information relating to an identifier associated with an NC generation, (2) a new generation indication (NGI) field, and/or (3) a new data indication (NDI) field. In one example, the method might include (e.g., prior to receipt of the DCI) receiving configuration information that indicates to apply NC in an UL transmission. For example, the uplink transmission may be a PUSCH transmission. The method may include determining, based on the DCI, first information comprising any of (1) a number of NC protocol data units (PDUs) to be transmitted via a transport block (TB) in the uplink transmission wherein the NC PDUs are generated using the NC generation associated with the identifier, (2) whether the DCI is scheduling a transmission for a new NC generation or a current NC generation, and/or (3) whether to retransmit a redundant version (RV) of a transport block (TB) that has already been transmitted or transmit a TB that carries a new redundant NC protocol data unit (PDU). For example, the determination of whether the DCI is scheduling a transmission for a new NC generation or a current NC generation may be based on the new generation indication (NGI) field of the DCI. For example, the determination of whether to retransmit a redundant version (RV) of a transport block (TB) that has already been transmitted or transmit a TB that carries a new redundant NC protocol data unit (PDU) may be based on an interpretation rule associated with the NDI field of the DCI. The method may include transmitting, to a network element, the TB in accordance with the determined first information.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example block diagram of a NC as a protocol in packet data convergence protocol (PDCP), according to an embodiment;

FIG. 3 illustrates an example flow diagram of a process for selection and/or transmission of NC PDUs, according to an embodiment; and

FIG. 4 illustrates an example flow diagram of a method, according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

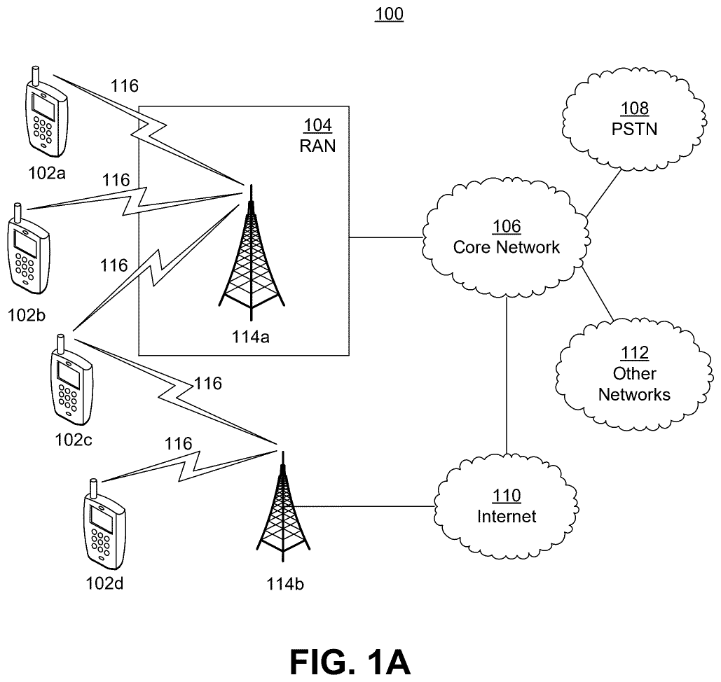

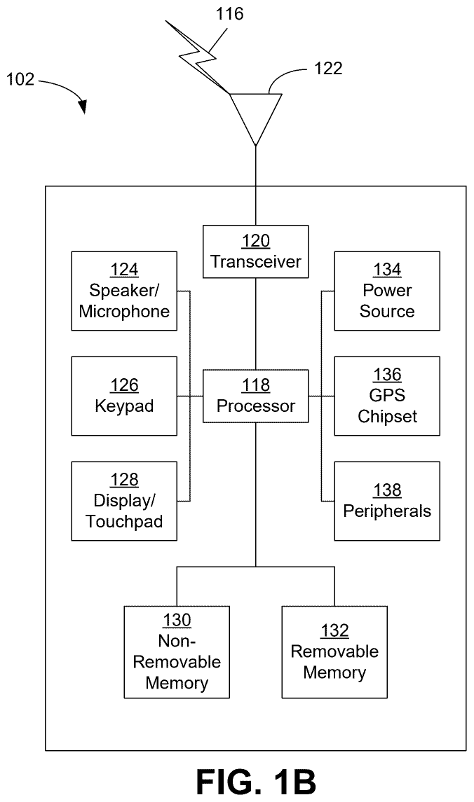

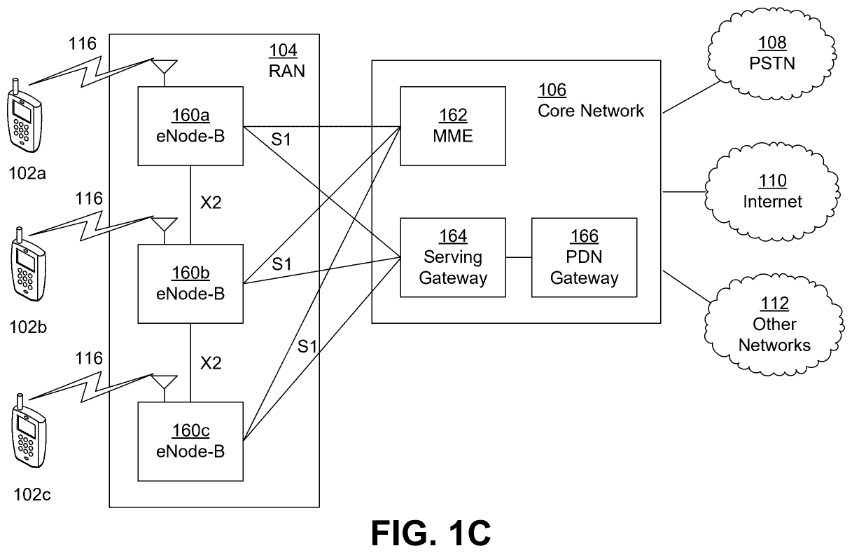

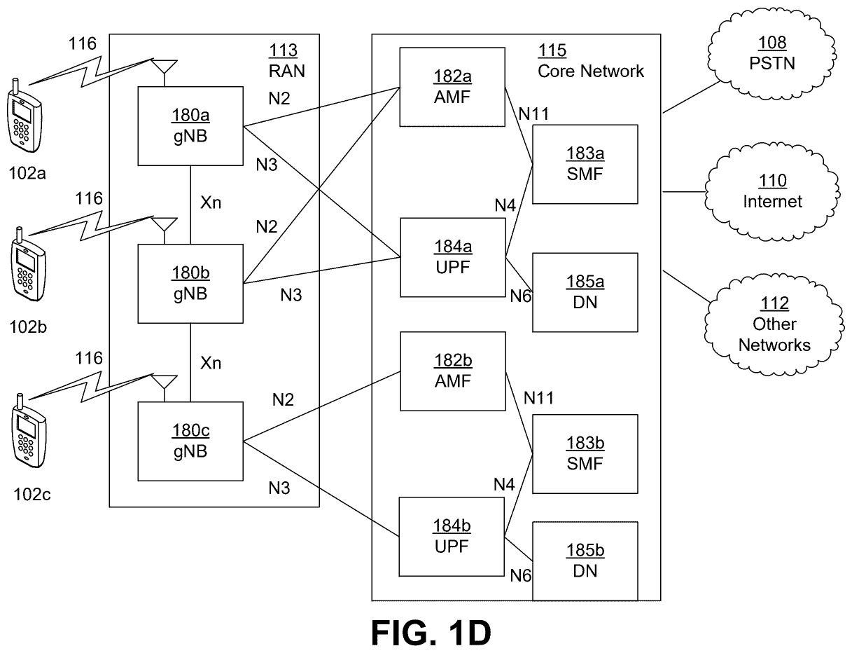

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11 ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Network coding may refer to a packet processing function that transforms X input packet(s) (or source packets) into Y output packet(s), which may be denoted as coded packet(s) hereinafter. For example, any of the Y (output packet(s)) may be a different linear combination of the same X input packets. In general, X is greater or equal to 2 and Y is greater or equal to X, with the case where X is equal to 1 and Y is equal to 1 being a special case. The X input packets being coded together form a network coding (NC) generation (which may be denoted hereinafter as a generation or NC generation).

An NC generation includes one or more NC-SDUs or NC-SDU segments, which may be used to generate NC PDUs for that NC generation. Thus, NC PDUs refers to the output data from the NC, where each NC PDU is a different linear combination of the NC SDUs or NC SDU segments that form the NC generation being encoded into NC PDUs. NC PDUs may differ from one another since each NC PDU is the result of different linear combinations of one or more NC SDUs or SDU-segments of a generation. As an example, a first NC PDU is the output of a coding process that performs a linear combination of one or more “NC SDUs or NC SDU-segments” of a NC generation using a first set of coefficients, and a second NC PDU is the output of a coding process that performs a linear combination of one or more “NC SDUs or NC SDU-segments” of the NC generation using a second set of coefficients (where the first set of coefficients and the second set of coefficients are different).

From the receiver perspective, when it receives at least X out of Y transmitted coded packets, it can recover the transmitted information. As a result, in some scenarios, even if receipt of some of the transmitted coded packets has failed, the whole transmission can still be successful.

In current NR, there is one independent hybrid-ARQ (HARQ) entity per serving cell and one transport block is generated per assignment/grant per serving cell. The MAC entity includes a HARQ entity for each serving cell, which maintains a number of parallel HARQ processes. Each HARQ process is associated with a HARQ process identifier.

In NR, there is no explicit HARQ acknowledgement (ACK) feedback for physical uplink shared channel (PUSCH). A WTRU determines whether the PUSCH is successfully delivered or not based on whether it receives a retransmission request from the network (e.g., from a network element, base station or gNB) or not. If the network does not send a retransmission request (e.g., DCI 0_0/0_1 with NDI not toggled) for a HARQ process, the WTRU may assume that PUSCH is successfully received and decoded by the network.

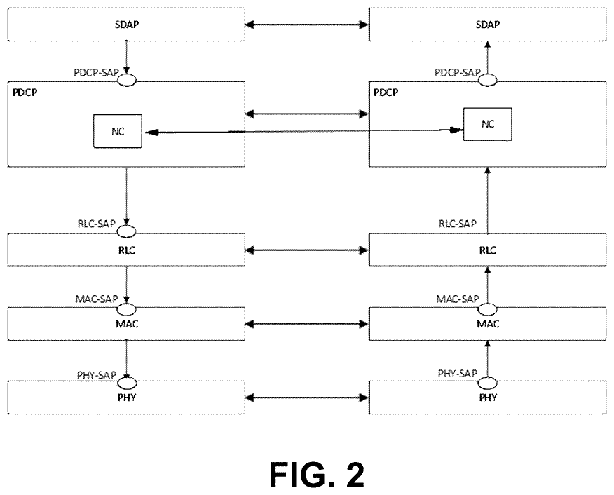

FIG. 2 illustrates an example block diagram of a NC as a protocol in packet data convergence protocol (PDCP). The introduction of NC in PDCP, as shown in the example of FIG. 2, may lead to increase in HARQ retransmission overhead, and overall transmission delay incurred at the HARQ level since Y packets are transmitted instead of X with Y≥X. Therefore, enhancements are desirable for UL HARQ operation with network coding in PDCP leveraging the fact that only X out of Y transmitted packets need to be successfully received at the receiver.

For example, NC PDUs from the same NC generation (or different NC generation) may be multiplexed into one or more Transport Blocks (TBs) based on their characteristics (e.g., type and/or importance levels). In this case, different TBs may carry correlated and/or dependent NC PDUs. The issues relating to how the transmitting (TX) WTRU determines when to transmit NC PDUs for a new NC generation, when to transmit new NC PDUs for the current NC generation, and when to retransmit NC PDUs with RV for the current NC generation in the PUSCH need to be addressed.

Thus, some example embodiments described herein provide at least enhancements to UL HARQ operation for dynamically scheduled PUSCH transmission with network coding to reduce HARQ feedback overhead, HARQ retransmission overhead, overall transmission delay and improve cell capacity.

Some embodiments may be directed to enhanced TB-based HARQ processing for dynamically scheduled UL with NC located above HARQ, for example. As introduced above, for dynamic grant (DG) UL transmission, the problem arises regarding how the WTRU determines how to perform retransmission to improve cell capacity leveraging the fact that only X out of Y transmitted packets need to be successfully received at the receiver. According to an embodiment, a WTRU may determine when to transmit NC PDUs for a new generation, when to transmit NC PDUs for the current NC generation and/or when to retransmit NC PDUs for the current NC generation in the scheduled PUSCH based on a new DCI field, e.g., a new generation indication field, and a new interpretation rule for the existing new data indication field in the DCI dynamically scheduling the PUSCH.

For example, an embodiment may introduce or provide a new DCI field (e.g., a new generation indication field) and new interpretation rule for the existing new data indication field in the DCI dynamically scheduling the PUSCH, for the Tx WTRU to determine when to transmit NC PDUs for a new NC generation, when to transmit NC PDUs for the current NC generation, and/or when to retransmit NC PDUs for the current NC generation in the scheduled PUSCH.

In an embodiment, a WTRU may be configured to apply network coding in the PUSCH transmission (e.g., the WTRU may receive configuration information indicating to apply network coding in an uplink transmission), where the NC PDUs generated from the same NC generation are transmitted using one or more TBs.

According to an embodiment, the WTRU may receive the DCI carrying the UL grant scheduling the PUSCH transmission. In addition to the legacy information, the WTRU may determine one or more of following NC related information from the received DCI: (i) an identifier or sequence number of an NC generation, (ii) the number of NC PDUs to be transmitted in the PUSCH scheduled by the DCI, for the NC generation whose identifier is indicated by the scheduling DCI, (iii) whether the DCI is scheduling the transmission for a new NC generation, for example, through or based on the new generation indication (NGI) field, and/or (iv) whether the WTRU needs to retransmit a RV of the TB that has been already transmitted, or transmit a TB that is carrying new redundant NC PDUs, e.g., through or based on a new interpretation rule for the NDI field.

In an embodiment, the WTRU may generate the data to be transmitted in the PUSCH based on the received DCI (e.g., based on the information indicated in the DCI). For example, if the WTRU receives the DCI with the NGI field toggled for a NC generation, the WTRU may determine that the current NC generation has been successfully decoded by the network (e.g., gNB). In this case, the WTRU may flush the HARQ processes (e.g., all of the HARQ processes) associated with this NC generation. The WTRU transmits the NC PDUs from a new NC generation in the PUSCH scheduled by the DCI.

If the WTRU receives the DCI with the NGI field not toggled for a NC generation, the WTRU may determine that the current NC generation has not been successfully decoded by the network (e.g., gNB). In this case, the WTRU may continue to transmit the NC PDUs for the current NC generation in the PUSCH scheduled by the DCI. The WTRU may further determines whether it should perform new transmission or retransmission for the current NC generation. For example, if the WTRU receives the DCI with the new data indication (NDI) field set to ‘0’, the WTRU may transmit a new TB carrying one or more new NC PDUs for the current NC generation in the PUSCH scheduled by the DCI. If the WTRU receives the DCI with the new data indication (NDI) field set to ‘1’, the WTRU may retransmit the TB carrying one or more NC PDUs using the redundant version (RV) indicated in the DCI for the current NC generation in the PUSCH scheduled by the DCI.

It is noted that, as used herein, current NC generation may refer to the NC generation whose associated NC PDUs have been transmitted in PUSCH using previously scheduled resources and the WTRU awaits the HARQ ACK/NACK feedback for its NC PDUs. New NC generation may refer to the NC generation whose associated NC PDUs have not been transmitted in PUSCH yet.

In this disclosure, the WTRU is “configured with” may refer to the scenario that the WTRU receives a configuration from a network element, base station, gNB, or another node (e.g., group coordinator UE). For the case that the WTRU receive configuration from the gNB, the WTRU may receive a dedicated RRC configuration or SIB from the gNB. For the case that the WTRU receive configuration from another node, the WTRU may receive configuration via sidelink communication (e.g., PC5 RRC), for example.

It is noted that the WTRU being “configured” or “(pre)-configured” to perform an action may also refer to the scenario that the WTRU is hard coded to perform the action via standard specifications.

Some example embodiments described herein may be based on the assumption that MAC/HARQ entity knows about how NC SDUs are coded and the corresponding NC PDUs. For example, the MAC/HARQ entity knows: (a) NC generation, i.e., NC SDUs coded together, and the NC generation identifier or sequence number associated with each NC generation; (b) NC PDUs associated with the same NC generation, for example MAC or HARQ entity may receive from upper layers, the NC generation identifier associated with each NC PDU; and (c) importance or characteristics (e.g. systematic packet, innovative packet, erasure correction packet or error correction packet, etc.) of each NC PDU. In some examples, each TB may carry one or more NC PDUs from one or more NC generations.

As introduced above, certain example embodiments include enhanced TB-based HARQ processing for dynamically scheduled UL. In some embodiments, the WTRU may determine information relating to the transmission of NC PDUs from scheduling DCI. In one embodiment, the WTRU may determine or obtain one or more information elements (or characteristics) relating to NC PDU(s) transmission from a received DCI carrying the UL grant scheduling a PUSCH. The information element(s) relating to NC PDU transmission may include: (1) an identifier or sequence number of an NC generation(s), (2) the number of NC PDUs, for the NC generation, to be transmitted in the PUSCH (denoted as N in the following) scheduled by the DCI, (3) an indication of whether the DCI is scheduling the transmission for a new NC generation, (4) an indication of whether to retransmit NC PDUs or transmit new NC PDUs of (e.g., associated with) an NC generation, and/or (5) the type of PDUs carried in the PUSCH. For example, the type or characteristics of NC PDU may include any one or more of: systematic NC PDUs, non-systematic NC PDU, coded NC PDUs, importance of NC PDUs, innovativeness of NC PDUs, innovative packet, less-innovative NC PDU, more-innovative NC PDU, size of NC SDU, size of NC PDU, erasure correction packet or error correction packet, non-NC PDUs etc.

With respect to the identifier or sequence number of NC generation, for example, a WTRU may be configured to transmit NC PDUs from an NC generation in a transport block (TB) in a PUSCH and the scheduling DCI may indicate the index of the corresponding NC generation.

With respect to the number of NC PDUs to be transmitted in the PUSCH (denoted as N in the following) scheduled by the DCI for the NC generation, for example, a WTRU may be configured to transmit NC PDUs from an NC generation in a transport block (TB) in a PUSCH and the scheduling DCI may have a field indicating a value of N for the NC generation whose NC PDUs are to be transmitted in the PUSCH scheduled by the DCI. This field may be ignored by a WTRU that may autonomously determine number of NC PDUs to be transmitted in PUSCH from an NC generation, e.g., for an initial transmission of NC PDUs from a new NC generation.

With respect to the indication of whether the DCI is scheduling the transmission for a new NC generation, for example, a WTRU may be configured to transmit NC PDUs from an NC generation in a transport block (TB) in a PUSCH and the scheduling DCI may indicate whether the PUSCH can carry NC PDUs from a new NC generation.

With respect to the indication of whether to retransmit NC PDUs or transmit new NC PDUs of an NC generation, for example, a WTRU may be configured to transmit NC PDUs from an NC generation in a transport block (TB) in a PUSCH and the scheduling DCI may indicate whether to retransmit previously transmitted NC PDUs or transmit new NC PDUs associated with the same NC generation.

With respect to the type of NC PDUs carried in the PUSCH, for example, the DCI may include information to identify the type and/or characteristics of the PDUs (e.g., systematic NC PDUs, non-systematic NC PDUs, coded NC PDUs, importance of NC PDUs, innovativeness of NC PDUs (e.g., less-innovative NC PDU, more-innovative NC PDU), size of NC SDU, size of NC PDU, non-NC PDUs or PDUs which are not NC coded, etc.) that can be carried in the PUSCH. The WTRU may use this indication to determine which PDUs can be (re) transmitted in a scheduled HARQ process.

The length of each of these fields in the DCI may be either fixed, e.g. defined in standards specification, or configured by the network (semi)-statically via L1/L2/L3 control signalling, for example.

According to some example embodiments, a WTRU may transmit uplink control information (UCI) carrying or indicating the NC related information (e.g., as discussed above) to assist the network or gNB in decoding and/or scheduling decisions. For example, the WTRU may transmit NC related information in UCI for DG PUSCH to assist the gNB decoding and/or scheduling decisions (e.g. transmission of additional NCP PDUs or retransmission of NC PDUs). The WTRU may transmit information in the UCI to determine or indicate any one or more of: the identifier or sequence number of NC generation, the number of NC PDUs to be transmitted in PUSCH, the minimum number of NC PDUs required to recover the NC SDUs of an NC generation, NC SDU or NC PDU size, and/or type of PDUs (or type of NC PDUs) carried in the PUSCH.

For example, with respect to the identifier or sequence number of NC generation, a WTRU may autonomously select NC generation(s) whose NC PSUs can be transmitted in a transport block (TB) in PUSCH and the UCI may indicate index of the corresponding NC generation. This field may be called, for example, NC generation identifier field in UCI. In one example, the length of this field may be pre-configured, e.g., hard coded in specifications or (semi)-statically configured by the network. In another example, the length of this field may be indicated by the UE, e.g., as will be described below. In another example, the length of this field may be determined based on maximum number of NC generations that can be multiplexed in a TB in PUSCH which may be (pre)-configured for a UE. In one example, if length of the field to indicate identifier for one NC generation is K bits and a WTRU is configured to multiplex maximum G NC generations in a TB in PUSCH, the length of NC generation identifier field may be G. K bits. In another example, the WTRU may use a bitmap, with length equal to maximum number of NC generations that can be multiplexed in a TB in PUSCH, to indicate identifiers of NC generations whose NC PDUs are carried in PUSCH. There may be a pre-configured association between index of each bit in the bitmap and the NC generation number. An example scenario where this approach may be used is when more than one NC generations can be multiplexed in a TB in PUSCH.

For example, with respect to the number of NC PDUs to be transmitted in PUSCH, a WTRU may be (pre)-configured with the maximum number of NC PDUs (denoted as Nₘₐₓ in the following) that can be transmitted in a TB, and/or the WTRU may be further configured to transmit log₂ (Nₘₐₓ) bits in UCI to indicate the number of NC PDUs transmitted (denoted as N in the following) in the associated PUSCH for an NC generation.

For example, with respect to the minimum number of NC PDUs required to recover the NC SDUs of an NC Generation, the WTRU may indicate the minimum number of NC PDUs (i.e., X) required to recover the NC SDUs of an NC Generation. The length of this field may be pre-configured, e.g., hard coded in specifications or (semi)-statically configured by the network.

For example, with respect to the NC SDU or NC PDU size, the WTRU may indicate size of NC SDU or NC PDU of an NC generation in the UCI.

For example, with respect to the type of PDUs carried in the PUSCH, the WTRU may indicate the type and/or characteristics of the PDUs (e.g., systematic NC PDUs, importance of NC PDUs, innovativeness of NC PDUs, size of NC SDU, size of NC PDU, etc.) in the UCI.

Certain example embodiments may include encoding of one or more information elements in UCI. In an embodiment, a WTRU may perform joint channel coding of bits for one or more of the information elements in UCI carrying NC related information for PUSCH. For example, the WTRU may perform joint channel coding using an error correction coding scheme based on total number of bits to be transmitted in the UCI.

In an embodiment, a WTRU may perform separate channel coding for one or more information elements in UCI carrying NC related information for PUSCH. For example, the WTRU may encode a first set of one or more information elements of UCI separately from a second set of one or more information elements of the UCI. The WTRU may send information about second set of one or more information elements of UCI in a first set of one or more information elements of the UCI. For example, the WTRU may indicate a length of one or more fields in a second set of one or more information elements of UCI in a first set of one or more information elements of the UCI.

Some example embodiments may include a WTRU procedure for determination of an NC generation sequence number or index. In an embodiment, WTRU may determine the index or sequence number of the NC generation whose NC PDUs can be transmitted in a PUSCH from a field in the DCI scheduling the PUSCH. This field, which may explicitly indicate the NC generation index or sequence number, may be called NC generation identifier field. In one example, the length of this field may depend on the of maximum number of NC generations that can be multiplexed in a TB in PUSCH.

In an embodiment, the index or sequence number of the NC generation may be implicitly indicated, for example, via a mapping or association between NC generation indexes or sequence numbers and the HARQ process IDs. For example, there may be an association or mapping between the NC generation indexes and the HARQ process IDs via pre-configuration, etc. A WTRU may determine an NC generation index or sequence number from the HARQ process number indicated in the DCI scheduling the PUSCH based on the pre-configured mapping. In another example, when the WTRU autonomously selects NC generation whose NC PDUs are transmitted in PUSCH, an association between a HARQ process ID and current NC generation index is established upon transmission of NC PDUs in PUSCH. Upon reception of subsequent DCI scheduling PUSCH for the same HARQ process, the sequence number/identifier of the current NC generation may be implicitly determined by the WTRU based on this association between HARQ process ID and NC generation index.

Some example embodiments may include WTRU procedures to determine whether to transmit NC PDUs from a new NC generation. According to an embodiment, a WTRU may determine whether to transmit NC PDUs from a new NC generation based on a new DCI field. For example, in an embodiment, the WTRU may determine whether to transmit NC PDUs from a new generation, e.g., in a TB on PUSCH, based on the indication in a new DCI field, e.g., new generation indication (NGI) field. The WTRU can determine whether NC PDUs from a current NC generation have been successfully delivered or not based on whether NGI field is toggled or not (e.g., based on a value of the NGI field). For example, when the WTRU receives an UL scheduling DCI and the WTRU determines that the NGI is toggled (e.g., the NGI is set to a first value), the WTRU may transmit the NC PDUs associated with the current NC generation in the PUSCH. Otherwise (e.g., if the NGI is not toggled or is set to a second value), the WTRU may transmit the NC PDUs associated with a new NC generation in the PUSCH.

In certain example embodiments, a WTRU may determine whether to transmit NC PDUs from a new NC generation based on HARQ process ID and/or NC generation identifier field in DCI. For example, according to an embodiment, a WTRU may determine whether to transmit NC PDUs from a new generation, e.g., in a TB on PUSCH, based on the HARQ process ID for which UL grant is received and/or the received index in the NC generation identifier field in the scheduling DCI. For example, when a WTRU receives an UL scheduling DCI for a certain HARQ process identified by the HARQ process number (HPN) in the DCI and the index in the NC generation identifier field in the DCI is different from the index associated with the NC generation whose NC PDUs were transmitted in the last grant for the same HARQ process ID, the WTRU determines that the grant is for transmission of NC PDUs from a new NC generation. Otherwise, if the index indicated in the NC generation identifier field is the same as previously indicated in a DCI for the same HARQ process, the WTRU determines that the grant is for transmission of NC PDUs from the same NC generation.

In certain example embodiments, a WTRU may determine whether to transmit NC PDUs from a new NC generation based on an NDI field. For example, according to an embodiment, a WTRU may determine whether to transmit NC PDUs from a new NC generation, e.g., in a TB on PUSCH, based on whether an NDI field in the scheduling DCI is toggled or not (e.g., whether it is set to a certain value). For example, when there is a preconfigured mapping between HARQ process IDs and the NC generation indexes or when the WTRU autonomously selects NC generation whose NC PDUs are transmitted in PUSCH, the current and new NC generation index may be implicitly determined by the WTRU based on an association between HARQ process IDs and current and/or new NC generation indexes. In this case, a WTRU may determine to transmit NC PDUs from a new NC generation upon receiving an UL scheduling DCI with NDI toggled (e.g., set to a first value), which implies that the NC PDUs from current NC generation in the identified HARQ process have been successfully delivered. Otherwise, if NDI in the scheduling DCI is not toggled (e.g., is set to a second value), the WTRU may determine that the NC PDUs from the current NC generation have not been successfully delivered and may determine to transmit NC PDUs from the current NC generation.

Some example embodiments may include WTRU procedures to determine a transmission scheme for current NC generation. In certain example embodiments, a WTRU may determine whether to transmit new NC PDUs from a current NC generation based on NDI field. According to an embodiment, when a WTRU determines to transmit NC PDUs from a current NC generation in PUSCH scheduled by DCI, the WTRU may further determine a transmission scheme, such as whether to transmit new NC PDUs from a current NC generation or retransmit NC PDUs (i.e., transmit previously transmitted NC PDUs using the same or different RV), based on the value of NDI field in the scheduling DCI. For example, if the WTRU receives the DCI with NDI field set to ‘0’, the WTRU determines to transmit a new TB carrying one or more new NC PDUs for the current NC generation in the PUSCH scheduled by the DCI. Otherwise, if the WTRU receives the DCI with new NDI field set to ‘1’, the WTRU determines to retransmit the TB carrying one or more NC PDUs using the redundant version (RV) indicated in the DCI for the current NC generation in the PUSCH scheduled by the DCI. In another example, if the WTRU receives the DCI with NDI field set to ‘1’, the WTRU determines to transmit a new TB carrying one or more new NC PDUs for the current NC generation in the PUSCH scheduled by the DCI. Otherwise, if the WTRU receives the DCI with new NDI field set to ‘0’, the WTRU determines to retransmit the TB carrying one or more NC PDUs using the redundant version (RV) indicated in the DCI for the current NC generation in the PUSCH scheduled by the DCI.

Example embodiments, such as the one discussed above, may be used for example when a WTRU determines whether to transmit NC PDUs from a new NC generation or not based on toggling of NGI field.

In an embodiment, when a WTRU determines to transmit NC PDUs from a current NC generation in PUSCH scheduled by DCI, the WTRU may further determine a transmission scheme, such as whether to transmit new NC PDUs from the current NC generation or retransmit NC PDUs (i.e., transmit previously transmitted NC PDUs using the same or different RV)) based on whether the NDI field in the scheduling DCI is toggled or not (e.g., based on a value indicated in the NDI field). For example, when the WTRU receives UL scheduling DCI with NDI field toggled, the WTRU transmits new NC PDUs from the current NC generation in the PUSCH. Otherwise, if NDI field is not toggled, the WTRU performs retransmission of NC PDUs from the current NC generation in the PUSCH. This approach may be used, for example, when a WTRU determines whether to transmit NC PDUs from a new NC generation based on HARQ process ID and NC generation identifier field in DCI, e.g., as discussed above.

In some example embodiments, a WTRU may determine whether to transmit new NC PDUs from a current NC generation based on a RV field. For example, according to an embodiment, when a WTRU determines to transmit NC PDUs from a current NC generation in PUSCH scheduled by DCI, the WTRU may further determine whether to transmit new NC PDUs from the current NC generation or retransmit NC PDUs based on the indication in the RV field in DCI. For example, when RV is set to all 0s (or same as previous PUSCH for the same HARQ process), the WTRU may transmit new NC PDUs associated with the current NC generation. When RV is set to other values (or different RV from the previous PUSCH for the same HARQ process), the WTRU may retransmit the NC PDU (according to the indicated RV) from the current NC generation.

In some example embodiments, a WTRU may determine whether to transmit new NC PDUs from a current NC generation based on HPN. For example, according to an embodiment, when a WTRU determines to transmit NC PDUs from a current NC generation in PUSCH scheduled by DCI, the WTRU may further determine whether to transmit new NC PDUs from the current NC generation based on HPN. For example, there may be a pre-configured association between HPN and the NC PDU transmission scheme (i.e., whether to transmit new NC PDUs or retransmit NC PDUs) from a current NC generation. The WTRU may determine whether to transmit new NC PDUs or retransmit NC PDUs from the current NC generation based on the pre-configured NC PDU transmission scheme for the identified HARQ process.

In some example embodiments, a WTRU may determine whether to transmit new NC PDUs from a current NC generation based on a number of NACKed transmission. For example, according to an embodiment, when a WTRU determines to transmit NC PDUs from a current NC generation in PUSCH scheduled by DCI, the WTRU may further determine whether to transmit new NC PDUs from the current NC generation based on the number of NACKed transmissions from the current NC generation. For example, a WTRU may perform retransmission of the NC PDUs from the current NC generation if number of NACKed transmissions is equal to or above a threshold. Otherwise, if number of NACKed transmissions is equal to or below a threshold, the WTRU may transmit new NC PDUs associated with the current NC generation.

In one embodiment, a WTRU may determine number of NACKed transmissions at the granularity level of each individual HARQ process associated with a current NC generation. For example, for a HARQ process l transmitting NC PDUs from an NC generation i, when the WTRU receives an UL scheduling DCI and the WTRU determines that the previous NC PDUs were not delivered successfully to the receiver, the WTRU may increment number of NACKed transmissions by 1.

In another embodiment, a WTRU may determine number of NACKed transmissions at the granularity level of number of NC PDUs per HARQ process associated with the current NC generation. For example, for a HARQ process l transmitting NC PDUs from an NC generation i, when the WTRU receives an UL scheduling DCI and the WTRU determines that the previous NC PDUs were not delivered successfully to the receiver, the WTRU may increment number of NACKed transmission by number of NC PDUs which were transmitted in the previous scheduled PUSCH for HARQ process l and NC generation i.

In another embodiment, the WTRU may determine number of NACKed transmissions for all the HARQ processes associated with the current NC generation to determine the NC PDU transmission scheme (i.e., whether to transmit new NC PDUs or retransmit NC PDUs) from the current NC generation. For example, for all L HARQ processes transmitting NC PDUs from an NC generation i, the WTRU may associate and maintain one counter to track accumulated number of NACKed transmissions. When the WTRU receives an UL scheduling DCI for any of the L HARQ processes and the WTRU determines that the previous NC PDUs were not delivered successfully to the receiver, a WTRU may increment the counter number of NACKed transmissions for NC generation i by 1.

In another embodiment, a WTRU may determine number of NACKed transmissions at the granularity level of number of NC PDUs for all the HARQ processes associated with the current NC generation to determine the NC PDU transmission scheme from the current NC generation. For example, for all L HARQ processes transmitting NC PDUs from an NC generation i, the WTRU may associate and maintain one counter to track accumulated number of NACKed transmissions. When the WTRU receives an UL scheduling DCI for any of the L HARQ processes, e.g., for HARQ process l, and the WTRU determines that the previous NC PDUs for HARQ process I were not delivered successfully to the receiver, the WTRU may increment the counter number of NACKed transmissions for NC generation i by the number of NC PDUs which were transmitted in the previous scheduled PUSCH for HARQ process l and NC generation i.

When the WTRU receives an UL scheduling DCI and it determines to transmit NC PDUs from a current NC generation, the WTRU may further determine the number of NACKed transmissions, e.g., as described above. When a WTRU determines that the number of NACKed transmissions is equal to or below a threshold, the WTRU may transmit new NC PDUs associated with NC generation i in the scheduled PUSCH for HARQ process l and NC generation i. Otherwise, the WTRU may retransmit NC PDUs from the NC generation i which were transmitted at the last scheduled PUSCH for HARQ process I and NC generation i.

In some example embodiments, a WTRU may determine whether to transmit new NC PDUs from the current NC generation based on NC configuration. For example, in an embodiment, when a WTRU determines to transmit NC PDUs from a current NC generation in PUSCH scheduled by DCI, the WTRU may further determine whether to transmit new NC PDUs from the current NC generation or retransmit NC PDUs from the current NC generation based on the NC configuration associated with current NC generation. For example, the WTRU may determine NC PDU transmission scheme (i.e. whether to transmit new NC PDUs or retransmit NC PDUs) for the current NC generation based on any one or more of NC code rate and/or NC generation size. For example, the WTRU may determine to transmit new NC PDUs from a current NC generation if the NC code rate for the current NC generation is equal to or below a (pre)-configured threshold otherwise the WTRU may retransmit NC PDUs from the current NC generation or vice versa. For example, the WTRU may determine to transmit new NC PDUs from a current NC generation if the NC generation size for the current NC generation is equal to or above a (pre)-configured threshold; otherwise, the WTRU may retransmit NC PDUs from the current NC generation or vice versa.

In some example embodiments, a WTRU may determine whether to transmit new NC PDUs from a current NC generation based on a number of NC PDUs transmitted. For example, in an embodiment, when a WTRU determines to transmit NC PDUs from a current NC generation in PUSCH scheduled by DCI, the WTRU may further determine whether to transmit new NC PDUs from the current NC generation based on the accumulated number of NC PDUs which have been transmitted from the current NC generation. For example, a WTRU may perform retransmission of the NC PDUs from the current NC generation if accumulated number of transmitted NC PDUs is equal to or above a threshold. Otherwise, if accumulated number of transmitted NC PDUs is equal to or below a threshold, the WTRU may transmit new NC PDUs associated with the current NC generation.

In an embodiment, a WTRU may determine accumulated number of transmitted NC PDUs at the granularity level of NC generation to determine the NC PDU transmission scheme from the current NC generation. For example, for all L HARQ processes transmitting NC PDUs from an NC generation i, the WTRU may associate and maintain one counter to track accumulated number of transmitted NC PDUs. When the WTRU receives an UL scheduling DCI for any of the N HARQ processes, e.g. for HARQ process l, and the WTRU transmits new NC PDUs associated with the current NC generation in the scheduled PUSCH resources, the WTRU may increment the counter by the number of new NC PDUs transmitted in the PUSCH. When the WTRU receives an UL scheduling DCI for any HARQ process l, and the WTRU determines to transmit NC PDUs from the current NC generation i in scheduled PUSCH resources, the WTRU may transmit new NC PDUs associated with the current NC generation i if the value of the counter for NC generation i is equal to or below a threshold. Otherwise, the WTRU may retransmit NC PDUs from the NC generation i which were transmitted at the last scheduled PUSCH for HARQ process I and NC generation i.

In an embodiment, a WTRU may determine accumulated number of transmitted NC PDUs at the granularity level of each HARQ process associated with the current NC generation to determine the NC PDU transmission scheme. For example, for L HARQ processes transmitting NC PDUs from an NC generation i, the WTRU may associate and maintain L, counters such that l-th counter may track accumulated number of transmitted NC PDUs for HARQ process l associated with the current NC generation. When the WTRU receives an UL scheduling DCI for HARQ process l, and the WTRU determines to transmit NC PDUs from the current NC generation i in scheduled PUSCH resources, the WTRU may transmit new NC PDUs associated with the current NC generation i if the value of l-th counter for NC generation i is equal to or below a threshold. Otherwise, the WTRU may retransmit NC PDUs from the NC generation i which were transmitted at the last scheduled PUSCH for HARQ process I and NC generation i.

In some example embodiments, a WTRU may determine whether to transmit new NC PDUs from a current NC generation based on configuration (e.g. based on receiving configuration information). For example, in an embodiment, when a WTRU determines to transmit NC PDUs from a current NC generation in PUSCH scheduled by DCI, the WTRU may further determine whether to transmit new NC PDUs from the current NC generation based on configured WTRU behavior. For example, in one embodiment, the WTRU behavior may be hardcoded via standard specifications such that a WTRU may transmit either (e.g., always transmit either) new NC PDUs from the current NC generation or perform retransmission of NC PDUs from the current NC generation. In another example, a WTRU may be configured by the network to either transmit new NC PDUs from the current NC generation or perform retransmission of NC PDUs from the current NC generation.

Some example embodiments may include a WTRU procedure to determine PDU type and/or characteristics for transmission in PUSCH. In an embodiment, a WTRU may determine type and/or characteristics of PDUs to be carried in PUSCH based on an explicit indication in DCI. For example, according to an embodiment, a WTRU may determine type and/or characteristics of the PDUs (e.g., systematic NC PDUs, non-systematic NC PDUs, coded NC PDUs, importance of NC PDUs, innovativeness of NC PDUs, less-innovative NC PDU, more-innovative NC PDU, size of NC SDU, size of NC PDU, non-NC PDUs etc.) that can be carried in the PUSCH based on explicit indication in scheduling DCI. An existing field (e.g., RV) in the DCI may be reused to indicate the type and/or characteristic(s) of PDUs that can be carried in the PUSCH. For example, when a WTRU determines from received DCI that NC PDUs are to be transmitted from the current NC generation (e.g., as discussed in detail above), and the WTRU further determines that new NC PDUs are to be transmitted from the current NC generation (e.g., based on example embodiments discussed above), the WTRU may determine the type and/or characteristics of NC PDUs that the WTRU can transmit in the PUSCH based on RV field in the scheduling DCI.

In an embodiment, a WTRU may implicitly determine type and/or characteristics of PDUs to be carried in PUSCH based on HARQ process number. For example, according to an embodiment, a WTRU may be pre-configured with the association between HARQ process number and the type and/or characteristics of PDUs that can be carried in PUSCH scheduled for the HARQ process.

For example, a WTRU may receive configuration information indicating one or more types of PDUs that can be carried for each HARQ process. For instance, one HARQ process may be configured to carry only NC PDUs, another HARQ process may be configured to carry only no NC PDUs and another HARQ process may be configured to carry NC PDUs and/or no NC PDUs.

In another example, a WTRU may receive configuration information indicating which HARQ processes are allowed to carry NC PDUs. The HARQ processes for which this indication is not received may be assumed to be allowed to carry PDUs which are not NC coded.

In another example, a WTRU may receive configuration information indicating which HARQ processes are not allowed to carry NC PDUs. The HARQ processes for which this indication is not received may be assumed to be allowed to carry NC PDUs.

In one example, when a WTRU receives an UL scheduling DCI, a WTRU may determine which PDUs to transmit in the PUSCH based on the identified HARQ process and pre-configured association with the PDU type and/or characteristics.

In some example embodiments, a WTRU may determine whether to transmit new NC PDUs from a current NC generation based on a type of NC PDUs transmitted. For example, in an embodiment, when a WTRU determines to transmit NC PDUs from a current NC generation in PUSCH scheduled by DCI, the WTRU may further determine whether to transmit new NC PDUs from the current NC generation based on one or more types of NC PDUs which have been transmitted from the current NC generation. For example, the type or characteristics of NC PDUs may include any one or more of: systematic NC PDUs, non-systematic NC PDUs, coded NC PDUs, importance of NC PDUs, innovativeness of NC PDUs, innovative packet, less-innovative NC PDU, more-innovative NC PDU, size of NC SDU, size of NC PDU, erasure correction packet or error correction packet, non-NC PDUs, etc.

As an example, a WTRU may perform retransmission of the NC PDUs from the current NC generation if the one or more types of previously transmitted NC PDUs included systematic NC PDUs and non-systematic NC PDUs. In another example, the WTRU may transmit new NC PDU if the one or more types of the previously transmitted NC PDUs include only systematic NC PDUs, or only non-systematic NC PDUs.

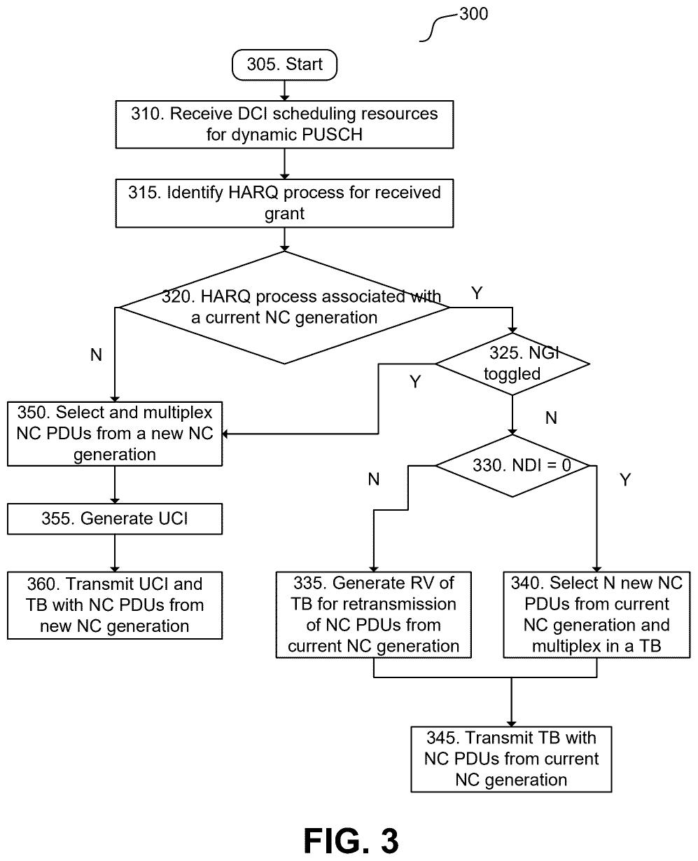

FIG. 3 illustrates an example flow diagram of a method 300 for selection and/or transmission of NC PDUs in a dynamically scheduled uplink channel (e.g., PUSCH), according to an embodiment. In one example, the method 300 may be performed or implemented by a WTRU, such as any of WTRUs 102a, 102b, 102c, 102d, discussed above. In other examples, the method 300 may be performed by another network element or node. In some examples, the method 300 depicts a realization of the selection and transmission and/or retransmission of NC PDUs when a WTRU transmits NC PDUs in the dynamically scheduled PUSCH resources. It should also be understood that one or more of the steps of the method 300 may be optional, may be omitted, and/or may be performed in a different order.

As shown in the example of FIG. 3, the method 300 may start at 305. The method 300 may include, at 310, receiving the DCI carrying the UL grant scheduling the uplink transmission (e.g., PUSCH transmission). The DCI may carry or indicate, e.g., possibly in addition to legacy fields, any of the following information elements: new generation indication (NGI) field, number of NC PDUs (which may be denoted as N) for the NC generation to be transmitted in the uplink transmission (e.g., PUSCH transmission), and/or indication for a WTRU to determine a retransmission scheme for the current NC generation (e.g. via NDI).

In the example of FIG. 3, the method 300 may include, at 315, identifying HARQ process for the received grant. At 320, the method 300 may include determining whether the identified HARQ process is associated with a current NC generation. If the identified HARQ process is not associated with a current NC generation, it may be assumed that the grant is for transmission of NC PDUs from a new NC generation and the method 300 may proceed to step 350.

As illustrated in the example of FIG. 3, the method 300 may include, at 350, performing a resource allocation procedure for selection and/or multiplexing of NC PDUs from a new NC generation in a TB. At 355, the method 300 may include generating UCI to transmit NC related information to assist the network (e.g., gNB) in decoding and/or scheduling decisions (e.g., transmission of additional NCP PDUs or retransmission of NC PDUs). The UCI may include any of: a NC generation identifier for the NC generation whose NC PDUs are multiplexed in the TB for transmission on the uplink channel (e.g., PUSCH), a number of NC PDUs from the NC generation in the TB, and/or minimum number of NC PDUs required to recover NC SDUs associated with NC generation etc. The method 300 may then include, at 360, transmitting UCI and TB including NC PDUs from the new NC generation in uplink (e.g., PUSCH) in the scheduled resources.

In the example of FIG. 3, if it is determined (at 320) that the identified HARQ process is associated with a current NC generation, the method 300 may include, at 325, determining whether the DCI is scheduling the transmission for a new NC generation, e.g. through or based on the new generation indication (NGI) field. For example, if NGI is not toggled (e.g., set or not set to a certain value), it may be assumed that NC PDUs from a current NC generation are to be transmitted and the method 300 may proceed to step 330. Otherwise, if NGI is toggled (e.g., set or not set to a certain value), then it can be assumed that NC PDUs from a new NC generation can be transmitted and the method 300 may proceed to step 350 discussed above.

As shown in the example of FIG. 3, the method 300 may include, at 330, determining the transmission scheme of NC PDUs from the current NC generation, e.g., based on NDI. For example, if the NDI field in a received DCI is set to ‘0’, it may be determined to transmit a new TB carrying one or more new NC PDUs (indicated by N in the received DCI) for the current NC generation in the PUSCH scheduled by the DCI and the method 300 may proceed to step 340. Otherwise, if the NDI field in a received DCI is set to ‘1’, it may be determined to retransmit the TB carrying NC PDUs for the current NC generation in the PUSCH scheduled by the DCI and the method 300 may proceed to step 335.

In the example of FIG. 3, the method 300 may include, at 335, generating a redundancy version (RV) of the TB for transmission of previously transmitted NC PDUs according to the RV indicated in the DCI and the method 300 may proceed to step 345.

In the example of FIG. 3, the method 300 may include, at 340, selecting N new NC PDUs from the current NC generation for transmission on the uplink channel (e.g., PUSCH) and the method 300 may proceed to step 345.

As further illustrated in the example of FIG. 3, the method 300 may include, at 345, transmitting the TB including NC PDUs from the current NC generation on the uplink channel (e.g., PUSCH).

It is noted that the flow diagram illustrated in FIG. 3 is provided as one example, and modifications thereto are contemplated according to certain embodiments as discussed elsewhere herein. For example, one or more of the steps illustrated in FIG. 3 may be omitted, combined, modified and/or performed in a different order, as provided in the example embodiments discussed herein.

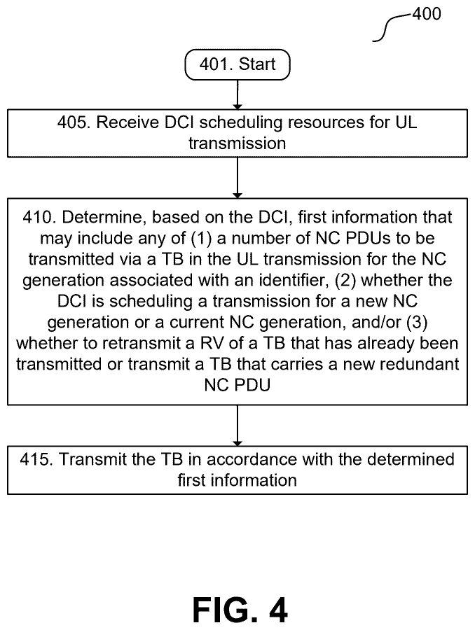

FIG. 4 is an example flow diagram illustrating an example method 400 relating to the selection and/or transmission of NC PDUs. For example, the method 400 may be directed to TB-based HARQ processing for dynamically scheduled UL with NC, according to some example embodiments. The example method of FIG. 4 and accompanying disclosures herein may be considered an application, generalization and/or synthetization of the various disclosures discussed above. For convenience and simplicity of exposition, the example of FIG. 4 may be described with reference to the architecture or system described above with respect to FIGS. 1A-1D and/or FIG. 2, for instance. However, the example method depicted in FIG. 4 may be carried out using different architectures as well. According to some embodiments, the method of FIG. 4 may be implemented by a UE or WTRU, such as the WTRU 102 described in the foregoing. For instance, in one example embodiment, the method of FIG. 4 may be implemented by any of the entities or layers illustrated in the example of FIG. 2 discussed above. Further, the method of FIG. 4 may be modified to include any of the steps, procedures, portions of procedures and/or details illustrated in the example of FIG. 3. Moreover, it is noted that the method and/or blocks of FIG. 4 may be modified to include, or to be replaced by, any one or more of the procedures or blocks discussed elsewhere herein. As such, one of ordinary skill in the art would understand that FIG. 4 is provided as one example and modifications thereto are possible while remaining within the scope of certain example embodiments.

As illustrated in the example of FIG. 4, the method 400 may start at 401 and may include, at 405, receiving, from a network element, downlink control information (DCI) that includes a grant scheduling an uplink transmission. According to one embodiment, the DCI may include any of (1) information relating to an identifier associated with an NC generation, (2) a new generation indication (NGI) field, and/or (3) a new data indication (NDI) field. In an example embodiment, the method 400 might include (e.g., prior to receipt of the DCI) receiving configuration information that indicates to apply NC in an UL transmission. For example, the uplink transmission may be a PUSCH transmission.

In an example embodiment, the method 400 may include, at 410, determining, based on the DCI, first information comprising any of (1) a number of NC protocol data units (PDUs) to be transmitted via a transport block (TB) in the uplink transmission where the NC PDUs are generated using the NC generation associated with the identifier, (2) whether the DCI is scheduling a transmission for a new NC generation or a current NC generation, and/or (3) whether to retransmit a redundant version (RV) of a transport block (TB) that has already been transmitted or transmit a TB that carries a new redundant NC protocol data unit (PDU). For example, the determination of whether the DCI is scheduling a transmission for a new NC generation or a current NC generation may be based on the new generation indication (NGI) field of the DCI. For example, the determination of whether to retransmit a redundant version (RV) of a transport block (TB) that has already been transmitted or transmit a TB that carries a new redundant NC protocol data unit (PDU) may be based on an interpretation rule associated with the NDI field of the DCI. According to an example embodiment, the method 400 may include, at 415, transmitting, to a network element, the TB in accordance with the determined first information.

In an example embodiment, the method 400 may include determining, based on a value of the NGI field, whether to transmit the TB including NC PDUs associated with the current NC generation or to transmit the TB including NC PDUs associated with the new NC generation. For example, on condition that the NGI field indicates a first value, the transmitted TB comprises NC PDUs associated with the current NC generation. For example, on condition that the NGI field indicates a second value, the transmitted TB comprises NC PDUs associated with the new NC generation.

According to an example embodiment, the information relating to the identifier associated with an NC generation may include an explicit indication of the identifier associated with the NC generation. In another example embodiment, the information relating to the identifier associated with an NC generation may be a hybrid automatic repeat request (HARQ) process identifier, and the method 400 may include determining the identifier associated with the NC generation based on an association between HARQ process identifiers and NC generation identifiers.

In an example embodiment, the method 400 may include determining, based on the HARQ process identifier and a value of the NGI field, whether to transmit the TB including NC PDUs associated with the current NC generation or to transmit the TB including NC PDUs associated with the new NC generation. For example, on condition that a value indicated in the NGI field is a same value as previously indicated in a NGI field of a previous DCI that indicated the same HARQ process identifier, the transmitted TB may include NC PDUs associated with the current NC generation. As another example, on condition that a value indicated in the NGI field is a different value from that previously indicated in a NGI field of a previous DCI that indicated the same HARQ process identifier, the transmitted TB may include NC PDUs associated with the new NC generation.

According to an example embodiment, the method 400 may include determining, based on the interpretation rule associated with the NDI field, whether to transmit the TB including NC PDUs associated with the current NC generation or to transmit the TB including NC PDUs associated with the new NC generation. As one example, the interpretation rule may include or indicate that, on condition that the NDI field indicates a first value, the transmitted TB comprises one or more new NC PDUs associated with the current NC generation. As another example, the interpretation rule may include or indicate that, on condition that the NDI field indicates a second value, the transmitted TB is the redundant version (RV) of a TB that has already been transmitted or is a TB that carries a new redundant NC protocol data unit (PDU).

According to an example embodiment, the method 400 may include determining to transmit new NC PDUs associated with the current NC generation in the TB, based on any of: (1) a redundant version (RV) field of the DCI, (2) a hybrid automatic repeat request (HARQ) process identifier indicated in the DCI, (3) a number of non-acknowledged (NACK) transmissions associated with the current NC generation, (4) an NC configuration associated with the current NC generation, (5) an accumulated number of NC PDUs associated with the current NC generation that have been transmitted, and/or (6) types (or characteristics) of previously transmitted NC PDUs.

In one example embodiment, the DCI may further include or indicate information indicating a type (or characteristic) of the NC PDUs that can be carried in the TB. According to an embodiment, the method 400 may include receiving configuration information indicating an association between hybrid automatic repeat request (HARQ) process identifiers and types of NC PDUs (e.g., the configuration information discussed above may also include the information indicating the association). In an embodiment, the method 400 may include determining the type of the NC PDUs to be carried in the transmitted TB based on a HARQ process identifier indicated in the DCI and the association between the HARQ process identifiers and the types of NC PDUs.

For example, the type and/or characteristics of NC PDUs may include any one or more of: systematic NC PDUs, non-systematic NC PDUs, coded NC PDUs, importance of NC PDUS, innovativeness of NC PDUs, innovative packet, less-innovative NC PDU, more-innovative NC PDU, size of NC SDU, size of NC PDU, erasure correction packet or error correction packet, non-NC PDUs, etc.

According to an example embodiment, the method 400 may include transmitting, to the network element, uplink control information (UCI) indicating second information. For example, the second information may include any of: (1) an identifier associated with a selected NC generation, (2) an indication of a number of NC PDUs to be transmitted in the uplink transmission, (3) an indication of a minimum number of NC PDUs required to recover the NC service data units (SDUs) of an NC generation, (4) an indication of NC SDU or NC PDU size, and/or (5) an indication of a type of the NC PDUs carried in the uplink transmission. In some example embodiments, the method 400 may include performing joint channel coding of bits of the second information in the UCI, or performing separate channel coding for one or more bits of the second information in the UCI.

It is noted that “innovative NC PDU,” “innovativeness of NC PDUs,” “innovative packet” or the like, refers to a NC PDU that is linearly independent from previously transmitted or received NC PDUs within the context of a given NC generation. The term ‘innovative’ in relation with NC PDUs is to be understood herein as a degree of complexity or differences of the NC PDUs from the previously transmitted or received NC PDUs within the context of a given NC generation. “More-innovative NC PDU” refers to a NC PDU that includes information about a large number of input NC SDUs not used for the generation of the previously transmitted or received NC PDUs within the context of a given NC generation. More-innovative NC PDUs may be useful for recovering a large number of NC SDUs at the receiver. “Less-innovative NC PDU” refers to a NC PDU that includes information about a small number of input NC SDUs not used for the generation of the previously transmitted or received NC PDUs within the context of a given NC generation. Less-innovative NC PDUs may be useful for recovering of few NC SDUs at the receiver.

The terms “to recover the NC SDUs,” “recover NC SDUs,” “recover the transmitted information,” or the like, may be used herein in reference to a receiver recovering NC SDU(s) as a result of successful decoding of received PDUs, where the received PDUs are generated (at the transmitter) based on an NC generation formed by those NC SDU(s), i.e., using those NC SDUs as input to the NC encoding process.

It is noted that the flow diagram illustrated in FIG. 4 is provided as one example, and modifications thereto are contemplated according to certain embodiments as discussed elsewhere herein. For example, one or more of the steps illustrated in FIG. 4 may be omitted, combined (e.g., combined with one or more steps of FIG. 3), modified and/or performed in a different order, as provided in the example embodiments discussed herein.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically matcable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a s″ecific number of an introduced “laim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### ABBREVIATIONS AND/OR ACRONYMS

ACK Acknowledgement
CB Code Block
CBG Code Block Group
CE Control Element
CRC Cyclic Redundancy Check
DCI Downlink Control Information
DG Dynamic Grant
DL Downlink
HARQ Hybrid Automatic Repeat Request
HPN HARQ Process Number
LDPC Low-Density Parity Check
NACK Negative ACK
MAC Medium Access Control
MCS Modulation and Coding Scheme
MIMO Multiple Input Multiple Output
NC Network Coding
NDI New Data Indicator
NGI New Generation Indication
NCCB NC code block
NR New Radio
OFDM Orthogonal Frequency-Division Multiplexing
PDSCH Physical Downlink Share Channel
PHY Physical Layer
PUSCH Physical Uplink Shared Channel
RE Resource Element
RRC Radio Resource Control
RV Redundancy Version
SCB Source Code Block
TB Transport Block
TBS Transport Block Size
UCI Uplink Control Information
UE User Equipment
UL Uplink
URLLC Ultra Reliable Low Latency Communications.

What is claimed is:

1. A wireless transmit/receive unit (WTRU), comprising circuitry, including any of a processor, memory, transmitter and receiver, the circuitry configured to:
receive configuration information indicating to apply network coding (NC) in an uplink transmission;
receive, from a network element, downlink control information (DCI) that includes a grant scheduling the uplink transmission, wherein the DCI comprises any of (1) information relating to an identifier associated with an NC generation, (2) a new generation indication (NGI) field, and (3) a new data indication (NDI) field;
determine, based on the DCI, first information comprising any of (1) a number of NC protocol data units (PDUs) to be transmitted via a transport block (TB) in the uplink transmission wherein the NC PDUs are generated using the NC generation associated with the identifier, (2) whether the DCI is scheduling a transmission for a new NC generation or a current NC generation, based on the new generation indication (NGI) field of the DCI, and (3) whether to transmit a redundant version (RV) of a transport block (TB) that has already been transmitted or transmit a TB that carries a new redundant NC protocol data unit (PDU), based on an interpretation rule associated with the NDI field of the DCI; and
transmit, to a network element, the TB in accordance with the determined first information.

2. The WTRU of claim 1, wherein the circuitry is configured to, based on a value of the NGI field, determine whether to transmit the TB including NC PDUs associated with the current NC generation or to transmit the TB including NC PDUs associated with the new NC generation.

3. The WTRU of claim 2, wherein, on condition that the NGI field indicates a first value, the transmitted TB comprises NC PDUs associated with the current NC generation.

4. The WTRU of claim 2, wherein, on condition that the NGI field indicates a second value, the transmitted TB comprises NC PDUs associated with the new NC generation.

5. The WTRU of claim 1, wherein the information relating to the identifier associated with an NC generation comprises an explicit indication of the identifier associated with the NC generation.

6. The WTRU of claim 1, wherein the information relating to the identifier associated with an NC generation comprises a hybrid automatic repeat request (HARQ) process identifier, and the circuitry is configured to determine the identifier associated with the NC generation based on an association between HARQ process identifiers and NC generation identifiers.

7. The WTRU of claim 6, wherein the circuitry is configured to, based on the HARQ process identifier and a value of the NGI field, determine whether to transmit the TB including NC PDUs associated with the current NC generation or to transmit the TB including NC PDUs associated with the new NC generation.

8. The WTRU of claim 7, wherein, on condition that a value indicated in the NGI field is a same value as previously indicated in a NGI field of a previous DCI that indicated the same HARQ process identifier, the transmitted TB comprises NC PDUs associated with the current NC generation.

9. The WTRU of claim 7, wherein, on condition that a value indicated in the NGI field is a different value from that previously indicated in a NGI field of a previous DCI that indicated the same HARQ process identifier, the transmitted TB comprises NC PDUs associated with the new NC generation.

10. The WTRU of claim 1, wherein the circuitry is configured to, based on the interpretation rule associated with the NDI field, determine whether to transmit the TB including NC PDUs associated with the current NC generation or to transmit the TB including NC PDUs associated with the new NC generation.

11. The WTRU of claim 10, wherein the interpretation rule comprises that on condition that the NDI field indicates a first value, the transmitted TB comprises one or more new NC PDUs associated with the current NC generation.

12. The WTRU of claim 10, wherein the interpretation rule comprises that on condition that the NDI field indicates a second value, the transmitted TB is the redundant version (RV) of a TB that has already been transmitted.

13. The WTRU of claim 1, wherein the circuitry is configured to determine to transmit new NC PDUs associated with the current NC generation in the TB, based on any of: (1) a redundant version (RV) field of the DCI, (2) a hybrid automatic repeat request (HARQ) process identifier indicated in the DCI, (3) a number of non-acknowledged (NACK) transmissions associated with the current NC generation, (4) an NC configuration associated with the current NC generation, (5) an accumulated number of NC PDUs associated with the current NC generation that have been transmitted, and (6) types of previously transmitted NC PDUs.

14. The WTRU of claim 1, wherein the DCI further comprises information indicating a type of the NC PDUs that can be carried in the TB, wherein the type of the NC PDUs comprises any of:
systematic NC PDUs, coded NC PDUs, importance of NC PDUs, and innovativeness of NC PDUs.

15. The WTRU of claim 1, wherein the circuitry is configured to:
receive configuration information indicating an association between hybrid automatic repeat request (HARQ) process identifiers and types of NC PDUs; and
determine the type of the NC PDUs to be carried in the transmitted TB based on a HARQ process identifier indicated in the DCI and the association between the HARQ process identifiers and the types of NC PDUs.

16. The WTRU of claim 1, wherein the circuitry is configured to transmit, to the network element, uplink control information (UCI) indicating second information, wherein the second information comprises any of: (1) an identifier associated with a selected NC generation, (2) an indication of a number of NC PDUs to be transmitted in the uplink transmission, (3) an indication of a minimum number of NC PDUs required to recover the NC service data units (SDUs) of an NC generation, (4) an indication of NC SDU or NC PDU size, and (5) an indication of a type of the NC PDUs carried in the uplink transmission.

17. The WTRU of claim 16, wherein:
the circuitry is configured to perform joint channel coding of bits of the second information in the UCI, or
the circuitry is configured to perform separate channel coding for one or more bits of the second information in the UCI.

18. The WTRU of claim 1, wherein the uplink transmission comprises a physical uplink shared channel (PUSCH) transmission.

19. A method, comprising:
receiving configuration information indicating to apply network coding (NC) in an uplink transmission;
receiving, from a network element, downlink control information (DCI) that includes a grant scheduling the uplink transmission, wherein the DCI comprises any of (1) information relating to an identifier associated with an NC generation, (2) a new generation indication (NGI) field, and (3) a new data indication (NDI) field;
determining, based on the DCI, first information comprising any of (1) a number of NC protocol data units (PDUs) to be transmitted via a transport block (TB) in the uplink transmission wherein the NC PDUs are generated using the NC generation associated with the identifier, (2) whether the DCI is scheduling a transmission for a new NC generation or a current NC generation, based on the new generation indication (NGI) field of the DCI, and (3) whether to transmit a redundant version (RV) of a transport block (TB) that has already been transmitted or transmit a TB that carries a new redundant NC protocol data unit (PDU), based on an interpretation rule associated with the NDI field of the DCI; and
transmitting, to a network element, the TB in accordance with the determined first information.

20. The method of claim 19, comprising, based on a value of the NGI field, determining whether to transmit the TB including NC PDUs associated with the current NC generation or to transmit the TB including NC PDUs associated with the new NC generation.

21. The method of claim 20, wherein:
on condition that the NGI field indicates a first value, the transmitted TB comprises NC PDUs associated with the current NC generation; and
on condition that the NGI field indicates a second value, the transmitted TB comprises NC PDUs associated with the new NC generation.

22. The method of claim 19, wherein the information relating to the identifier associated with an NC generation comprises an explicit indication of the identifier associated with the NC generation.

23. The method of claim 19, wherein the information relating to the identifier associated with an NC generation comprises a hybrid automatic repeat request (HARQ) process identifier, and the method comprises determining the identifier associated with the NC generation based on an association between HARQ process identifiers and NC generation identifiers.

24. The method of claim 6, comprising, based on the HARQ process identifier and a value of the NGI field, determining whether to transmit the TB including NC PDUs associated with the current NC generation or to transmit the TB including NC PDUs associated with the new NC generation.

25. The method of claim 24, wherein:
on condition that a value indicated in the NGI field is a same value as previously indicated in a NGI field of a previous DCI that indicated the same HARQ process identifier, the transmitted TB comprises NC PDUs associated with the current NC generation; and
on condition that a value indicated in the NGI field is a different value from that previously indicated in a NGI field of a previous DCI that indicated the same HARQ process identifier, the transmitted TB comprises NC PDUs associated with the new NC generation.

26. The method of claim 19, comprising, based on the interpretation rule associated with the NDI field, determining whether to transmit the TB including NC PDUs associated with the current NC generation or to transmit the TB including NC PDUs associated with the new NC generation.

27. The method of claim 26, wherein:
the interpretation rule comprises that on condition that the NDI field indicates a first value, the transmitted TB comprises one or more new NC PDUs associated with the current NC generation; or
the interpretation rule comprises that on condition that the NDI field indicates a second value, the transmitted TB is the redundant version (RV) of a TB that has already been transmitted.

28. The method of claim 19, comprising determining to transmit new NC PDUs associated with the current NC generation in the TB, based on any of: (1) a redundant version (RV) field of the DCI, (2) a hybrid automatic repeat request (HARQ) process identifier indicated in the DCI, (3) a number of non-acknowledged (NACK) transmissions associated with the current NC generation, (4) an NC configuration associated with the current NC generation, (5) an accumulated number of NC PDUs associated with the current NC generation that have been transmitted, and (6) types of previously transmitted NC PDUs.

29. The method of claim 19, wherein the DCI further comprises information indicating a type of the NC PDUs that can be carried in the TB.

30. The method of claim 19, comprising:
receiving configuration information indicating an association between hybrid automatic repeat request (HARQ) process identifiers and types of NC PDUs; and
determining the type of the NC PDUs to be carried in the transmitted TB based on a HARQ process identifier indicated in the DCI and the association between the HARQ process identifiers and the types of NC PDUs.

31. The method of claim 19, comprising transmitting, to the network element, uplink control information (UCI) indicating second information, wherein the second information comprises any of: (1) an identifier associated with a selected NC generation, (2) an indication of a number of NC PDUs to be transmitted in the uplink transmission, (3) an indication of a minimum number of NC PDUs required to recover the NC service data units (SDUs) of an NC generation, (4) an indication of NC SDU or NC PDU size, and (5) an indication of a type of the NC PDUs carried in the uplink transmission.
